(19) United States
(12) Patent Application Publication
(10) Pub. No.: US 2019/0322355 A1
(43) Pub. Date: Oct. 24, 2019

(54) APPARATUS, AIRCRAFT AND METHOD OF MOVING A MOVABLY MOUNTED WING TIP DEVICE

(71) Applicant: Airbus Operations Limited, Bristol (GB)

(72) Inventors: Thomas WILSON, Bristol (GB); Andrea CASTRICHINI, Bristol (GB); Alvaro AZABAL, Bristol (GB)

(21) Appl. No.: 16/386,675

(22) Filed: Apr. 17, 2019

(30) Foreign Application Priority Data
Apr. 23, 2018 (GB) 1806555.7

(51) Int. Cl. B64C 9/14; B64C 9/02; B64C 13/50

(52) U.S. Cl. CPC B64C 9/146; B64C 13/50; B64C 9/02

(57) ABSTRACT

An apparatus (1000) is provided for controlling a movable wing tip device (9) of an aircraft (1). The apparatus includes an actuator (15) for moving the wing tip device from a load-alleviating configuration to a flight configuration; and a processor (10) which generates a signal for controlling operation of the aircraft so as to reduce the force required for the actuator to move the wing tip device from the load-alleviating configuration to the flight configuration. The apparatus may be included on an aircraft (1) and used in a method of moving the wing tip device from the load-alleviating configuration to the flight configuration during flight.

### BACKGROUND OF THE INVENTION

The present disclosure relates to aircraft with moveable wing tip devices.

The present invention concerns aircraft with a fixed wing portion and a movable wing tip device. More particularly, but not exclusively, this invention is an apparatus for controlling a movable wing tip device. The invention also concerns an aircraft comprising a fixed wing portion and a movable wing tip device and a method of moving a movably mounted wing tip device.

Aircraft with moveable wing tip devices attached to fixed wings are known to those skilled in the art. The wing tip devices are typically used to allow load alleviation during flight, for example, in the event of wind gusts. Typically, large loads cause the wing tip device to move from a flight configuration in which the wing tip device is effectively a continuation of the fixed wing portion to a load-alleviating configuration in which the load on the wing is reduced. Once the cause of the requirement to enter the load-alleviating configuration has passed, it is often desirable to move the wing tip device back into the flight configuration. This is typically done using an actuator. Typically, the larger the force required, the larger and heavier the actuator.

The present invention seeks to mitigate the above-mentioned problems. Alternatively or additionally, the present invention seeks to provide an improved method for moving the wing tip device of an aircraft from a load-alleviating configuration to the flight configuration.

### SUMMARY OF THE INVENTION

In accordance with a first aspect of the present invention, there is provided an apparatus for controlling a movable wing tip device of an aircraft, movable from (a) a load-alleviating configuration in which the wing tip device is oriented relative to the fixed wing such that at least one of the upper and lower surface of the wing tip device is positioned away from the respective surface of the fixed wing to (b) a flight configuration in which the upper and lower surfaces of the wing tip device are continuations of the upper and lower surfaces of the fixed wing. The apparatus comprises: a processor; an actuator for applying a force to the wing tip device for moving the wing tip device from the load-alleviating configuration to the flight configuration; and a controller for controlling operation of the actuator. The processor is configured: to receive a first signal indicative of whether or not the movable wing tip device is in the load-alleviating configuration; to receive a second signal indicative of the desire to move the movable wing tip device from the load-alleviating configuration to the flight configuration; and in response to the first signal being indicative that the movable wing tip is in the load-alleviating configuration and to the second signal being indicative of the desire to move the wing tip device into the flight configuration, to generate a first instruction for moving the wing tip device from the load-alleviating configuration to the flight configuration; and to generate a second instruction for controlling operation of the aircraft so as to reduce the force required for the actuator to move the wing tip device from the load-alleviating configuration to the flight configuration. The controller is configured to control operation of the actuator on receiving the first instruction from the processor.

The apparatus of the present invention permits a reduction in the amount of force required to move the wing tip device from the load-alleviating configuration into the flight configuration. This may permit the use of an actuator which may be less powerful, smaller and/or lighter than may otherwise be needed. The reduction in the force required for the actuator to move the wing tip device from the load-alleviating configuration to the flight configuration is preferably achieved by reducing the loading (for example the aerodynamic loading) on the wing tip device that is acting against the actuator.

Those skilled in the art will realise that the wing tip device, the fixed wing and the aircraft are not necessarily parts of the apparatus of the first aspect of the present invention.

The use of “first signal” and “second signal” does not imply that the first signal is received before the second signal. Likewise, the use of “first instruction” and “second instruction” does not imply that the first instruction is generated before the second instruction.

The apparatus may comprise a sensor for determining whether or not the wing tip device is in the load-alleviating configuration. Said sensor may be configured to provide the first signal. Said sensor may be configured to determine the angular displacement of the wing tip device from the flight configuration.

The wing tip device may be deployed into a load-alleviating configuration as a result of an excessive load generating event, such as a gust of wind. The second signal may therefore be indicative of the passing of such an excessive load generating event e.g. if the output of a sensor is consistent with the ending of an excessive load generating event. The second signal may be generated automatically, for example by a sensor, or may be generated manually, for example, by a crew member.

The second instruction may be for deploying one or more aircraft control surfaces, for example, one or more aircraft control surfaces provided on the fixed wing and/or one or more aircraft control surfaces provided on the wing tip device. The one or more aircraft control surfaces may comprise one or more ailerons, one or more flaps and/or one or more spoilers.

The second instruction may be for reducing the angle of attack of the fixed wing (and also of the aircraft) by manoeuvring the aircraft. The second instruction may be for rolling the aircraft, for example, by rolling the aircraft in a first roll direction and subsequently in a second roll direction different from the first roll direction. The second instruction may be for changing the pitch of the aircraft, for example, for increasing the pitch of the aircraft and then reducing the pitch of the aircraft.

The actuator may be coupled or coupleable to the wing tip device to move the wing tip device from the load-alleviating configuration to the flight configuration, and optionally to move the wing tip device from the flight configuration to the load-alleviating configuration. However, it is preferred that the actuator is configured so that it is not operable to move the wing tip device from the flight configuration to the load-alleviating configuration.

The apparatus may comprise a restraining assembly operable between a restraining mode in which the wing tip device is held in the flight configuration using a restraining force, and a releasing mode in which the restraining force on the wing tip device is released, such that the wing tip device is able to adopt the load-alleviating configuration. A restraining assembly actuator may be provided to control operation of the restraining assembly.

Once the restraining force on the wing tip device is released, the wing tip device is permitted to move according to the other forces applied to the wing tip device (e.g. aerodynamic forces resulting from flight). If the restraining force is removed, the wing tip device would typically move to the load-alleviating configuration, subject to other forces applied to the wing tip device as described below.

For example, the restraining assembly may comprise a brake, the operation of which is controlled by the restraining assembly actuator. The restraining assembly actuator will typically be used to release the brake on receipt of a suitable control signal, thereby removing the restraining force.

The apparatus may comprise a biasing member, arranged such that when the wing tip device is in the flight configuration, the biasing member exerts a biasing force to urge the wing tip device towards the load-alleviating configuration. Such an arrangement has been found to be beneficial because it tends to reduce the lag between the restraining assembly adopting the releasing mode, and the wing tip device actually moving to the load-alleviating configuration (the biasing force assisting the movement of the wing tip device into the load-alleviating configuration such that it is moved under the action of both the biasing force and aerodynamic forces). Having the restraining assembly in combination with this movable wing tip device may be referred to as a “semi-aeroelastic” arrangement). The biasing member may be elastically-deformable. The biasing member may comprise an actuator for urging the wing tip device into the load-alleviating configuration.

Having the biasing member may be beneficial in reducing flutter (for example, in increasing the speed at which flutter may occur).

When the restraining assembly is in the restraining mode, the biasing force is typically overcome by the restraining force. But, when the restraining assembly is in the releasing mode, the biasing force is typically sufficient to assist in moving the wing tip device into the load-alleviating configuration. In some embodiments, when the restraining assembly is in the releasing mode, the biasing force may be sufficient to move the wing tip device into the load-alleviating configuration. Such an arrangement provides reassurance that the wing tip device can move to the load-alleviating configuration, if needs be, even in the absence of aerodynamic forces acting on the wing tip device. Nevertheless, the wing tip device is more preferably arranged such that it may be moved from the flight configuration to the load-alleviating configuration, at least partially by aerodynamic forces acting on the wing tip device.

The biasing member may be able to be selectively disengaged from exerting the biasing force on the wing tip device. For example, the wing may comprise a clutch for selectively disengaging the biasing member from exerting the biasing force on the wing tip device. Such an arrangement has been found to be beneficial because it may enable the biasing member to be selectively disengaged to enable easier maintenance of the wing tip device.

The apparatus may comprise a damper arranged to damp movement of the wing tip device. Such an arrangement has been found to be beneficial, especially when the wing tip device is quickly moved to the load-alleviating configuration, as it tends to damp down transient, oscillatory, movements. A damper has also been found to be beneficial because it may mitigate aeroelastic instabilities such as flutter, and/or may limit cycle oscillations.

In other embodiments, the apparatus need not comprise any damper and/or biasing member. Indeed, in some embodiments the wing tip device may be entirely free to rotate when the restraining assembly is in the releasing mode (i.e. there may be substantially no other resistive forces acting to prevent rotation once the restraining force is removed). When the wing tip device is free to rotate in this manner, it may be referred to as ‘coasting’ or being arranged to ‘coast’. For some embodiments of the invention, having such an arrangement have been found to be especially beneficial. In such embodiments, the centre of gravity of the wing tip device may be positioned such that no substantive shear loads are passed into the wing tip and to ensure the flutter speed is sufficiently high.

The apparatus may comprise a latching arrangement for holding the wing tip device in the load-alleviating configuration. For example, the aircraft may comprise a ratchet and pawl configured to allow rotation of the wing tip device to the load alleviating configuration, and to then hold it in that configuration unless or until it is to be reverted to the flight configuration. Such an arrangement may be especially beneficial in embodiments in which there is no biasing member and/or damper because it enables the wing tip device to be ‘caught’ in the load-alleviating configuration (for example, once it has moved under aeroelastic forces once the restraining assembly is in the releasing configuration). The latching arrangement may be controllable to latch and/or release the wing tip device.

In accordance with the second aspect of the present invention, there is provided an aircraft comprising an apparatus in accordance with the first aspect of the present invention. The aircraft may comprise a movably mounted wing tip device which is moveable from a load-alleviating configuration to a flight configuration, the wing tip device being moveably mounted at the tip of a fixed wing of an aircraft, the fixed wing having an upper surface and a lower surface, and the wing tip device having an upper surface and a lower surface. In the flight configuration the upper and lower surfaces of the wing tip device are preferably continuations of the upper and lower surfaces of the fixed wing. In the load-alleviating configuration, the wing tip device may be oriented relative to the fixed wing such that at least one of the upper and lower surfaces of the wing tip device is positioned away from the respective surface of the fixed wing, and the lift provided by the wing is reduced relative to the flight configuration.

The apparatus of the first aspect of the present invention is used to control the movement of the wing tip device in the aircraft of the second aspect of the present invention.

The wing tip device may be rotatably mounted on a hinge at the tip of the wing, such that it may rotate, about the hinge, between the flight and load-alleviating configurations. In embodiments in which the wing tip device is also moveable to a ground configuration (a configuration to which the wing tip device may be moved when the aircraft is on the ground), the wing tip device is preferably so moveable about this same hinge.

The hinge is preferably orientated non-parallel to the line-of flight direction. The hinge is preferably orientated such that the hinge at the trailing edge of the wing is further inboard than the hinge at the leading edge of the wing. The hinge is preferably orientated such that in the load-alleviating configuration, the mean incidence of the wing tip device is reduced. The hinge is preferably orientated substantially perpendicular to the swept mean chord axis of the wing. The swept mean chord axis may be parallel to the longitudinal direction of the wing box. Such an arrangement has been found to be beneficial in terms of enabling a load reduction (in comparison with a hinge line that is orientated parallel to the line-of flight). Furthermore, such an orientation of hinge has been found to facilitate movement of the wing tip device to a stable load-alleviating configuration. For example, when the hinge is in such an orientation, the wing tip device tends to move to a static-aeroelastically stable position even under purely aerodynamic loading. This orientation of hinge is therefore especially beneficial in combination with the restraining assembly in embodiments of the invention. The orientation of the hinge may be chosen such that it acts to stabilise flutter.

The wing tip device may be rotatable, from the load-alleviating configuration to the flight configuration, in a downwards direction. The wing tip device may be rotatable, from the flight configuration to the load-alleviating configuration, in an upwards direction. The hinge may be a double hinge enabling both upwards or downward rotation. Providing such a double hinge has been found to be beneficial because it may enable loads from both upwards and downwards events (such as gusts) to be alleviated. Such an arrangement may also ensure the load-alleviating configuration does not inadvertently amplify loads, as might otherwise occur if the wing tip device is allowed to adopt this configuration in response to an event in the opposite direction to that intended.

The wing tip device may be a wing tip extension; for example the wing tip device may be a planar tip extension. In other embodiments, the wing tip device may comprise, or consist of, a non-planar device, such as a winglet.

In the flight configuration the trailing edge of the wing tip device is preferably a continuation of the trailing edge of the fixed wing. The leading edge of the wing tip device is preferably a continuation of the leading edge of the fixed wing. There is preferably a smooth transition from the fixed wing to the wing tip device. It will be appreciated that there may be a smooth transition, even where there are changes in sweep or twist at the junction between the fixed wing and wing tip device. However, there are preferably no discontinuities at the junction between the inner wing and wing tip device.

When the wing tip device is in the load-alleviating configuration, the aircraft incorporating the wing, is still suitable for flight, but the wing tip device is preferably moved to a position in which the lift provided by the wing is reduced. It will be appreciated that the load-alleviating configuration may encompass the wing tip device being in a range of positions (all of which reduce lift to some degree). The position (for example the magnitude of rotation about the hinge) may be dependent on the magnitude of load-alleviation that is sought. In the load-alleviating configuration the wing tip device remains attached to the fixed wing. The wing tip device may be repeatably moveable between the load-alleviating configuration and the flight configuration.

In embodiments in which the wing tip device is moveable to a ground configuration, the aircraft incorporating the wing, when the wing tip device is in the ground configuration, may be unsuitable for flight. For example, the wing tip device may be aerodynamically and/or structurally unsuitable for flight in the ground configuration. The aircraft is preferably configured such that, during flight, the wing tip device is not moveable to the ground configuration. The aircraft may comprise a sensor for sensing when the aircraft is in flight. When the sensor senses that the aircraft is in flight, a control system is preferably arranged to disable the possibility of moving the wing tip device to the ground configuration. In the ground configuration, the wing tip device may be rotated about the hinge by an angle greater than the maximum angle about which it is rotated in the load-alleviating configuration. In the ground configuration the wing tip device remains attached to the wing.

The aircraft may comprise one or more aircraft control surfaces. The one or more aircraft control surfaces may be deployable in response to the second instruction provided by the processor. The one or more aircraft control surfaces may be provided on the fixed wing and/or on the wing tip device. The one or more aircraft control surfaces may be provided on the wing tip device, for example, an aileron provided on the wing tip device. The one or more control surfaces may be provided on the fixed wing, for example, one or more flaps provided on the fixed wing. Deployment of one or more flaps may reduce the angle of attack of the wing, therefore reducing the force required for the actuator to move the wing tip device from the load-alleviating configuration to the flight configuration. The one or more control surfaces may comprise one or more spoilers, optionally provided on the fixed wing. The one or more spoilers, when deployed, may interfere with the airflow around the wing and wing tip, and reduce the lift experienced by the wing tip.

The one or more control surfaces may comprise one or more ailerons. Deployment of one or more ailerons (typically two in combination) may cause the aircraft to roll, reducing the force required for the actuator to move the wing tip device from the load-alleviating configuration to the flight configuration.

The aircraft is preferably a passenger aircraft. The passenger aircraft preferably comprises a passenger cabin comprising a plurality of rows and columns of seat units for accommodating a multiplicity of passengers. The aircraft may have a capacity of at least 20, more preferably at least 50 passengers, and more preferably more than 50 passengers. The aircraft is preferably a powered aircraft. The aircraft preferably comprises an engine for propelling the aircraft. The aircraft may comprise wing-mounted, and preferably underwing, engines.

Those skilled in the art will realise that typically the aircraft will be provided with a moveable wing tip at the end of each fixed wing portion.

The wingspan of the aircraft with the wing tip in the flight configuration is optionally no less than 52 m and optionally greater than 65 m. The wingspan of the aircraft with the wing tip in the lift-reducing or ground configuration is optionally no less than 52 m and no more than 65 m. The length of the wing tip device (measured along the longitudinal axis of the fixed wing portion) is optionally at least 1.0 m, optionally at least 1.5 m, optionally at least 2.0 m, optionally at least 2.5 m and optionally at least 3.0 m. The length of the wing tip device is optionally no more than 5.0 m, optionally no more than 4.5 m, optionally no more than 4.0 m, optionally no more than 3.5 m, optionally no more than 3.0 m and optionally no more than 2.5 m. The span ratio of the fixed wing relative to the wing tip device may be such that the fixed wing comprises 70%, 80%, 90%, or more, of the overall span of the aircraft wing.

In accordance with a third aspect of the present invention, there is provided a method of moving a movably mounted wing tip device from a load-alleviating configuration to a flight configuration during flight. The wing tip device is moveably mounted at the tip of a fixed wing of an aircraft, the fixed wing having an upper surface and a lower surface, and the wing tip device having an upper surface and a lower surface. In the flight configuration the upper and lower surfaces of the wing tip device are preferably continuations of the upper and lower surfaces of the fixed wing. In the load-alleviating configuration the wing tip device is preferably oriented relative to the fixed wing such that at least one of the upper and lower surfaces of the wing tip device is positioned away from the respective surface of the fixed wing, and the load on the wing is reduced relative to the flight configuration. The aircraft comprises an actuator for applying a force to the wing tip device for moving the wing tip device from the load-alleviating configuration to the flight configuration. The method comprises reducing the force required for the actuator to move the wing tip device from the load-alleviating configuration to the flight configuration.

The method of the present invention permits the wing tip device to be moved back to the flight configuration more easily. The actuator may be smaller, less powerful and/or lighter than may otherwise be required.

Reducing the force required for the actuator to move the wing tip device from the load-alleviating configuration to the flight configuration may comprise moving one or more aircraft control surfaces. For example, the wing tip device may be provided with one or more moveable aircraft control surfaces which may be deployed, for example, to reduce the lift exerted by the wing tip device. This reduction in lift would reduce the amount of force required for the actuator to move the wing tip device back to the flight configuration. Examples of such aircraft control surfaces include spoilers and ailerons.

Alternatively or additionally, the fixed wing of the aircraft may be provided with one or more control surfaces which may be deployed, thereby reducing the force needed for the actuator to move the wing tip device. For example, deployment of one or more flaps may increase lift and reduce the angle of attack of the wing, reducing the force required by the actuator to move the wing tip device back to the flight configuration from the load-alleviating configuration.

Reducing the force required for the actuator to move the wing tip device may comprise reducing the angle of attack of the fixed wing. This may comprise manoeuvring the aircraft.

Manoeuvring the aircraft may comprise rolling the aircraft, for example, by rolling the aircraft in a first roll direction and subsequently rolling the aircraft in a second roll direction opposite to the first roll direction.

Manoeuvring the aircraft may comprise reducing the pitch angle of the aircraft.

Manoeuvring the aircraft may comprise increasing the pitch angle of the aircraft and then reducing the pitch angle of the aircraft. For example, a parabolic manoeuvre where the aircraft pitches up and then back down again to achieve a load factor of less than 1 g.

The method may comprise determining whether or not the wing tip device is in the flight configuration or in the load-alleviating configuration. The method may comprise reducing the force required for the actuator to move the wing tip device from the load-alleviating configuration to the flight configuration dependent on the determination of whether or not the wing tip device is in the flight configuration or in the load-alleviating configuration.

The method may comprise determining the displacement of the wing tip device from the flight configuration. This may comprises determining the angular displacement of the wing tip device from the flight configuration.

The method may comprise using the actuator to move the wing tip device to the flight configuration.

It will of course be appreciated that features described in relation to one aspect of the present invention may be incorporated into other aspects of the present invention. For example, the method of the third aspect of the invention may incorporate any of the features described with reference to the control system of the first aspect of the invention and vice versa.

### DESCRIPTION OF THE DRAWINGS

Embodiments of the present invention will now be described by way of example only with reference to the accompanying schematic drawings of which:

FIG. 1a shows a schematic plan view of an apparatus and aircraft according to a first embodiment of the invention;

FIG. 1b shows a schematic plan view of a wing of the aircraft of FIG. 1a;

FIG. 2a shows schematic front view of the aircraft of FIGS. 1a and 1b;

FIGS. 2b, 2c and 2d show schematic front views of a portion of the wing of the aircraft of FIGS. 1a and 1b;

FIG. 3 shows a schematic plan view of the end portion of the wing of the aircraft of FIGS. 1a and 1b;

FIG. 4 shows a method according to an embodiment of the invention;

FIG. 5 shows lift distribution across the wing of an aircraft during flight, and the effect on lift distribution of deploying an aileron provided on the wing tip device;

FIG. 6 shows lift distribution across the wing of an aircraft during flight, and the effect on lift distribution of rolling the aircraft and of flying a parabolic flight path; and

FIG. 7 shows lift distribution across the wing of an aircraft during flight, and the effect on lift distribution of deploying flaps on the fixed wing of the aircraft.

### DETAILED DESCRIPTION

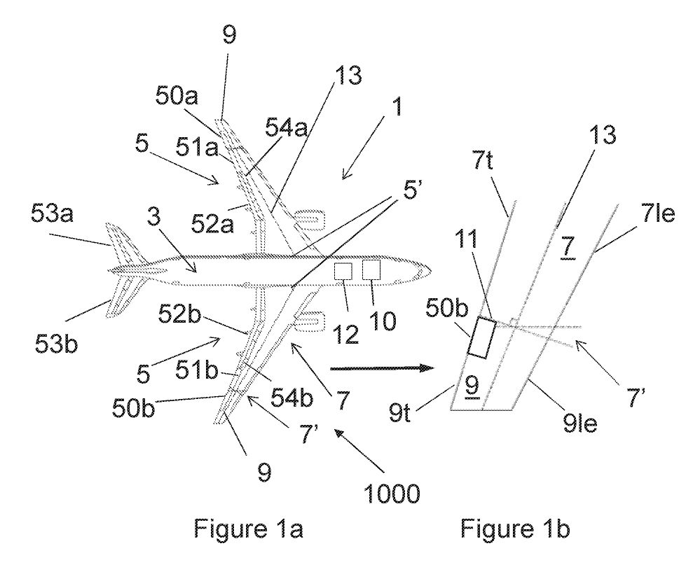

FIG. 1a is a plan view of an aircraft 1 according to a first embodiment of the invention. The aircraft comprises a central fuselage 3 and two main wings 5 extending outwardly from respective wing roots 5′.

Each wing 5 comprises a fixed wing 7 extending from the root 5′ to the tip 7′ (shown in close up in FIG. 1b). At the tip 7′ of the fixed wing 7, the wing 5 also comprises a moveable wing tip device 9, in the form of a planar wing tip extension. The wing tip device 9 is rotatably mounted about a hinge 11 that is orientated perpendicular to the swept mid-chord axis 13. This hinge 11, is thus non-parallel to the line of flight direction (the line of flight direction being shown in FIG. 1b for comparison).

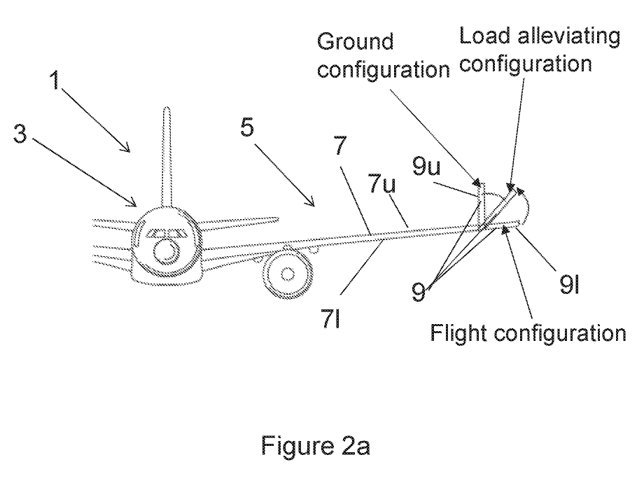

Referring now to FIGS. 2a to 2d, the wing tip device 9 is rotatable about the hinge 11 from a flight configuration to a load-alleviating configuration, to a ground configuration.

In the flight configuration, the wing tip device 9 is an extension of the fixed wing. Accordingly the upper 7u and lower 7l surfaces of the fixed wing 7 are continuous with the upper 9u and lower 9l surfaces of the wing tip device 9 (see FIG. 2b and the lowermost position in FIG. 2a). The leading 71e and trailing 7t edges of the fixed wing 7 are also continuous with the respective leading 91e and trailing 9t edges of the wing tip device 9 (see FIGS. 1a and 1b). Such an arrangement is beneficial as it provides a relatively large wing span, thereby providing an aerodynamically efficient aircraft. However a large span can result in correspondingly large loads on the wing 5, particularly a large wing root bending moment, especially during high load events such a gusts or extreme manoeuvres. The wing 5 must be sized to cope with these maximum loads, which can result in a relatively heavy wing. The ability of the wing tip device 9 to move to the load-alleviating configuration (see FIGS. 2a and 2c) seeks to address that problem.

As shown in FIG. 2c and the middle position in FIG. 2a, the wing tip device 9 is rotatable, upwards, such that the lower surfaces 7l, 9l between the fixed wing 7 and the wing tip device 9, are no longer continuous with one another. Furthermore, since the hinge 11 is angled with respect to the airstream-wise direction, when the wing tip device 9 rotates upwardly its mean incidence is reduced. In this configuration the lift generated by the wing 5 is significantly reduced and the load on the wing tip device is also significantly reduced. The wing tip device 9 is moveable to this configuration during flight (described in more detail below).

The wing tip device 9 is also configurable to a ground configuration in which the wing tip device 9 is rotated yet further, to a substantially upright position (shown in FIGS. 2a and 2d). The wing tip device is moveable to this configuration when it is on the ground (described in more detail below). Once rotated to such a position, the span of the aircraft 1 is sufficient to meet airport compatibility gate limits. Thus, the aircraft 1 of the first embodiment can have a large span (exceeding gate limits) during flight, but is still able to comply with gate limits when on the ground.

Load alleviation using moveable wing tip devices is known per se. Providing moveable wing tip device to meet airport compatibility gate limits is also known per se. The first embodiment of the invention relates to a reduction in the force required by an actuator to move the wing tip device from the load-alleviating configuration to the flight configuration.

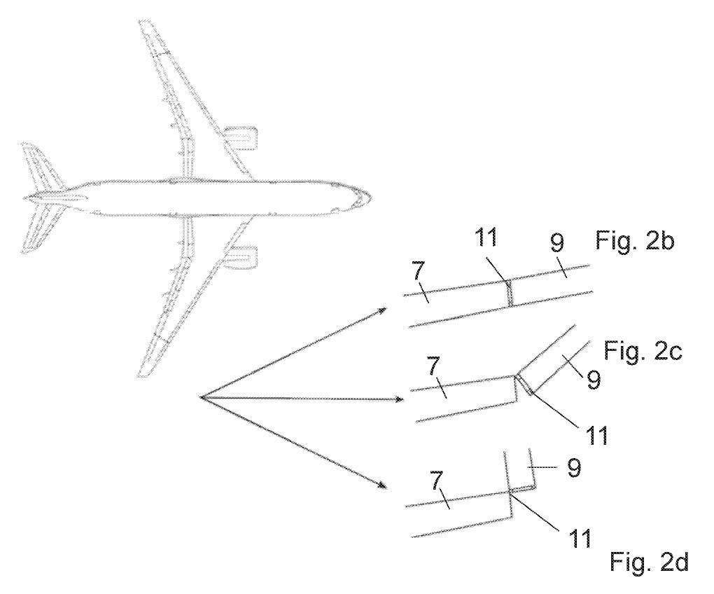

Referring to FIGS. 1a and 3, the aircraft 1 comprises an apparatus 1000 for controlling the wing tip device 9. The apparatus 1000 comprises a processor 10 configured to receive a first signal indicative of whether the wing tip or not the wing tip device 9 is in the load-alleviating configuration and to receive a second signal indicative of whether or not there is a desire to move the wing tip device from the load-alleviating configuration to the flight configuration. In this case, the first signal is provided by a sensor 60 located adjacent the wing tip device 9, and the second signal is provided by a wind speed sensor 12 located on the upper part of the fuselage of aircraft 1. If the processor determines that the wing tip device is in the load-alleviating state and that it is desirous to move the wing tip device to the flight configuration (for example, if the output of the wind speed sensor 12 indicates that a gusting event has passed), then the processor generates a first instruction which it sends to an actuator 15 in the form of a motor via controller 30 to move the wing tip device from the load-alleviating configuration to the flight configuration, and a second instruction which it sends to an aileron 50a, 50b provided on wing tip device 9. The deployment of the aileron 50a, 50b causes a reduction in the upward force applied to the wing tip device (or more preferably causes a downwards force to be applied to the wing tip), urging it towards the flight configuration, and reducing the force that the actuator 15 needs to exert on the wing tip device in order to bring the wing tip device 9 into the flight configuration. Similarly, spoilers (not shown) could be deployed to cause a reduction in the force required to move the wing tip device back to the flight configuration.

A second embodiment of the present invention will now be described with reference to FIGS. 1a and 3. As in the first embodiment of the present invention described above, the first signal is provided by a sensor 60 located adjacent the wing tip device 9, and the second signal is provided by the wind speed sensor 12. If the processor determines that the wing tip device is in the load-alleviating state (as indicated by sensor 60) and that it is desirous to move the wing tip device to the flight configuration (for example, if the output of the wind speed sensor 12 indicates that a gusting event has passed), then the processor generates a first instruction which it sends to the actuator 15 via the controller 30 to move the wing tip device from the load-alleviating configuration to the flight configuration. In the second embodiment of the invention, the processor sends a second instruction to ailerons 51a, 51b. This causes the aircraft to roll in a first roll direction, reducing the force that actuator 15 has to exert on a respective wing tip device in order to bring that wing tip device back into the flight configuration. Once the sensor associated with that wing tip device senses that that wing tip device is in the flight configuration, a signal is transmitted to the processor indicative of this condition, and then the processor transmits an instruction to the ailerons 51a, 51b consistent with rolling of the aircraft in a direction opposite to the first roll direction. This rolling manoeuver reduces the force which the actuator 15 associated with the other wing tip device has to exert on that wing tip device in order to move the wing tip device to the flight configuration.

A third embodiment of the invention will now be described with reference to FIGS. 1a and 3. As in the first and second embodiments, the processor 10 is configured to receive a first signal indicative of whether or not the wing tip device 9 is in the load-alleviating configuration and to receive a second signal indicative of whether or not there is a desire to move the wing tip device from the load-alleviating configuration to the flight configuration. The first signal is provided by a sensor 60 located adjacent the wing tip device 9, and the second signal is provided by the wind speed sensor 12. If the processor determines that the wing tip device is in the load-alleviating state and that it is desirous to move the wing tip device to the flight configuration (for example, if the output of the wind speed sensor 12 indicates that a gusting event has passed), then the processor generates a first instruction which it sends to an actuator 15 via controller 30 to move the wing tip device from the load-alleviating configuration to the flight configuration, and a second instruction which it sends to flaps 52a, 52b provided on fixed wing. The deployment of the flaps 52a, 52b causes an increase in lift and therefore causes the angle of attack of the aircraft to decrease, thereby reducing the force that the actuator 15 needs to exert on the wing tip device in order to bring the wing tip device 9 into the flight configuration.

A fourth embodiment of the invention will now be described with reference to FIGS. 1a and 3. As in the first, second and third embodiments, the processor 10 is configured to receive a first signal indicative of whether the wing tip or not the wing tip device 9 is in the load-alleviating configuration and to receive a second signal indicative of whether or not there is a desire to move the wing tip device from the load-alleviating configuration to the flight configuration. The first signal is provided by the sensor 60, and the second signal is provided by the wind speed sensor 12. If the processor determines that the wing tip device is in the load-alleviating state and that it is desirous to move the wing tip device to the flight configuration (for example, if the output of the wind speed sensor 12 indicates that a gusting event has passed), then the processor generates a first instruction which it sends to an actuator 15 via controller 30 to move the wing tip device from the load-alleviating configuration to the flight configuration, and a second instruction which it sends to elevators 53a, 53b provided on the aircraft tail. The deployment of the elevators 53a, 53b causes a decrease in the angle of attack of the aircraft, thereby reducing the force that the actuator 15 needs to exert on the wing tip device in order to bring the wing tip device 9 into the flight configuration.

A fifth embodiment of the invention will now be described with reference to FIGS. 1a and 3. As in the first, second, third and fourth embodiments, the processor 10 is configured to receive a first signal indicative of whether the wing tip or not the wing tip device 9 is in the load-alleviating configuration and to receive a second signal indicative of whether or not there is a desire to move the wing tip device from the load-alleviating configuration to the flight configuration. The first signal is provided by sensor 60 and the second signal is provided by the wind speed sensor 12. If the processor determines that the wing tip device is in the load-alleviating state and that it is desirous to move the wing tip device to the flight configuration (for example, if the output of the wind speed sensor 12 indicates that a gusting event has passed), then the processor generates a first instruction which it sends to an actuator 15 via controller 30 to move the wing tip device from the load-alleviating configuration to the flight configuration, and a second instruction which it sends to engine controllers to increase thrust, and therefore for the aircraft to climb. A further instruction is then transmitted to elevators to cause the aircraft to pitch upwards, and then transmitted to elevators to cause the aircraft to pitch downwards. This up-down-up flight pattern, which could, for example be a parabolic manoeuvre, may achieve a load factor of less than 1 g, and reduces the force that the actuator 15 needs to apply to the wing tip device to move the wing tip device from the load-alleviating configuration into the flight configuration.

A sixth embodiment of the invention will now be described with reference to FIGS. 1a and 3. As in the first, second, third and fourth embodiments, the processor 10 is configured to receive a first signal indicative of whether the wing tip or not the wing tip device 9 is in the load-alleviating configuration and to receive a second signal indicative of whether or not there is a desire to move the wing tip device from the load-alleviating configuration to the flight configuration. The first signal is provided by the sensor 60, and the second signal is provided by the wind speed sensor 12. If the processor determines that the wing tip device is in the load-alleviating state and that it is desirous to move the wing tip device to the flight configuration (for example, if the output of the wind speed sensor 12 indicates that a gusting event has passed), then the processor generates a first instruction which it sends to an actuator 15 via controller 30 to move the wing tip device from the load-alleviating configuration to the flight configuration, and a second instruction which it sends to spoilers 54a, 54b provided on the aircraft tail. The deployment of the spoilers 54a, 54b disturbs the airflow around the wing tip device, and reduces the amount of lift experienced by the wing tip device, thereby reducing the force that the actuator 15 needs to exert on the wing tip device in order to bring the wing tip device 9 into the flight configuration.

The embodiment of the apparatus 1000 in accordance with the present invention is further described below with reference to FIGS. 1a and 3. The apparatus 1000 comprises a controller 40 and a restraining assembly actuator 50, the controller 40 being communicatively coupled to the restraining assembly actuator 50 to permit the wing tip device 9 to move in response to receipt of the instruction from the processor 10.

The restraining assembly actuator 50 forms part of a restraining assembly 17 which is operable between a restraining configuration in which the wing tip device 9 is in the flight configuration and in which the wing tip device 9 is restrained from moving from the flight configuration, and a releasing configuration in which the restraining force on the wing tip device 9 has been removed and the wing tip device 9 is free to move, subject to other forces on the wing tip device 9 as described below.

The restraining assembly 17 also comprises a brake 19, a clutch 21, a rotational spring 23 and a rotational damper 25. The restraining assembly actuator 50 is coupled to the brake 19, and controls operation of the brake 19.

The brake 19 comprises two pads configured to selectively clamp against the shaft 18 to restrain its rotation. As mentioned above, the restraining assembly 17 is operable between a restraining mode (in which the brake 19 is deployed to brake the rotation of the shaft 18), and a releasing mode (in which the brake 19 is released by pulling the pads away from the shaft 18 to allow its free rotation (and thus the rotation of the wing tip device 9)).

The default (passive) mode of the restraining assembly 17 is the restraining mode in which the shaft 18 is braked. When the wing tip device 9 is in the flight configuration, the power to the restraining assembly 17 is switched OFF (i.e. the assembly is passive) and the restraining assembly 17 is left with the shaft 18 braked. Such an arrangement is attractive as it ensures an active command (e.g. an ON signal) is required to move the wing tip device). When power is supplied to the restraining assembly 17 via control 40, the control 40 activates the restraining assembly actuator 50 which releases brake 19.

In the present embodiment, sensor 12 is configured to measure wing speed. In the event of an excessive wind event, the output of sensor 12 will be indicative of such an event. The processor 10 is configured to receive signals from the sensor 12. On receipt of signals indicative of an excessive wind event, the processor 10 is configured to generate an instruction which is sent to controller 40 which transmits a signal to restraining assembly actuator 50 to release brake 19, thereby releasing the restraining assembly from the restraining mode, permitting movement of the wing tip device 9.

The wing tip device 9 may, at least partially, be moveable to the load-alleviating configuration purely under the action of aerodynamic force acting on it during flight. However, in the first embodiment of the invention, the restraining assembly comprises a rotational spring 23 and damper 25 arrangement to assist this movement. The rotational spring 23 and damper 25 are located at one end of the hinge 11. The rotational spring 23 is preloaded such that when the wing tip device 9 is in the flight configuration, it exerts a biasing force that urges the wing tip device 9 towards the load-alleviating configuration. That biasing force is unable to overcome the restraining force exerted by the brake 19 when it is deployed. However, when the brake 19 is released, the biasing force (in addition to aerodynamic forces acting on the wing tip device) acts to rotate the wing tip device 9 about the hinge 11. The rotational spring 23 is sized such that it rotates the wing tip device 9 by around 30 degrees of rotation (shown in FIG. 2c), but once the wing tip device 9 has rotated that far, the spring 23 is fully unwound and does not urge any further rotation. Providing a pre-loaded spring 23 in this manner has been found to be beneficial as it quickly moves the wing tip device 9 to the load alleviated configuration, as soon as the brake 19 has been released.

The damper 25 is configured to damp movement of the wing tip device 9 as it rotates under the action of the spring 23 (and any aerodynamic forces). Such an arrangement has been found to be beneficial, especially when the wing tip device 9 is quickly moved to the lift-reducing configuration, as it tends to damp down transient, oscillatory, movements. The spring damper may also assist in reducing or eliminating flutter and/or load cycle oscillations.

The restraining assembly also comprises a clutch 21 located on the hinge 11. The clutch 21 serves to selectively engage/disengage opposing ends of the hinge, such that the spring 23 can be selectively chosen to exert the biasing force on the wing tip device 9. Such an arrangement has been found to be beneficial because it may enable the spring 23 to be selectively disengaged to enable easier maintenance of the wing tip device 9.

As mentioned above, the actuator is in the form of a motor 15 which is connected to a drive shaft 18 that forms the shaft of the hinge 11. The wing tip device 9 is connected to the shaft 18 by a connecting piece 20. As well as being configured to move the wing tip device 9 from the load-alleviating configuration to the flight configuration, the motor 15 is arranged to rotate the wing tip device 9 between the flight configuration (see FIG. 2b) and the ground configuration (see FIG. 2d) by actuation of the motor 15. This typically occurs shortly after landing to enable the aircraft to comply with airport gate limits. This movement also happens in reverse before take-off, once the aircraft has cleared the gate.

When the aircraft is flying and the wing tip device is in the flight configuration, there tends to be a significant force on the wing tip (typically upwards). It has been recognised that using the motor 15 to actively hold down the wing tip device in the flight configuration, by applying a reverse torque, is undesirable; if using such an approach it would typically be necessary to also provide locks to permanently lock the wing tip device in that flight position during flight.

In the first embodiment, the motor 15 does not provide a reverse torque. Instead it is in a passive state such that it does not actively contribute to restraining the wing tip device 9 in the flight configuration, the apparatus 1000 instead being provided with the restraining assembly 17.

When the wing tip device has been moved to the load-alleviating configuration and it is desirous to move the wing tip device to the flight configuration, the motor 15 is, however, activated such that it rotates the wing tip device 9 back to the flight configuration and re-compresses the spring 23. Once back in the flight configuration, the restraining assembly 17 is switched back into restraining mode such that the brake 19 is applied, and the motor 15 is again returned to its passive state. Thus the motor 15 can be used not only to move the wing tip device between the flight and ground configurations, but also from the load alleviating configuration to the flight configuration (albeit not from the flight configuration to the load alleviating configuration).

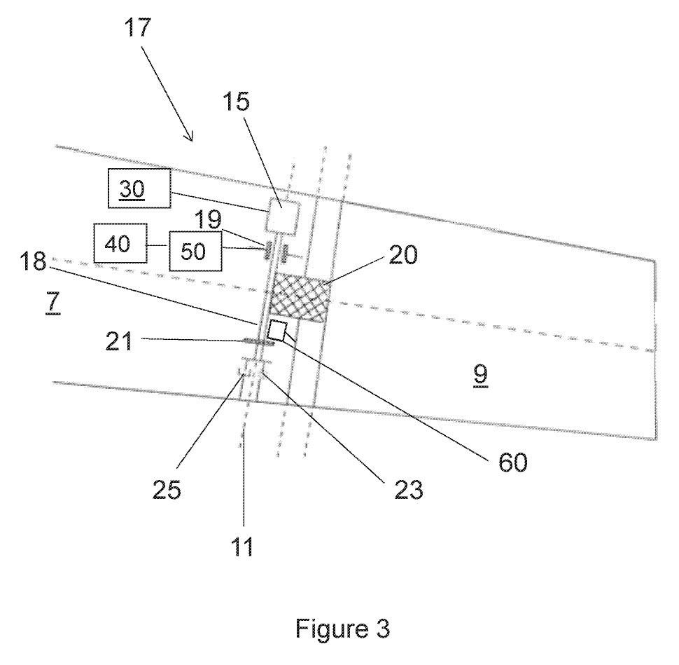

A general method 100 of moving a wing tip device from a load-alleviating configuration to a flight configuration will now be described with reference to FIGS. 1a, 3 and 4. Sensor 60 transmits a first signal 6001 to processor 10 which is indicative of whether or not the wing tip device 9 is in a load-alleviating configuration. Sensor 12 transmits a second signal 6002 which the processor 10 uses to determine 5002 whether or not it is desirous to move the wing tip device 9 into the flight configuration e.g. whether an excessive wind event has passed. If the wing tip device is in the load-alleviating configuration and if it is desirous to move the wing tip device into the flight configuration, then processor 10 transmits a first instruction 6003 to actuator 15 to cause the wing tip device 9 to be moved back to the flight configuration. Processor also transmits a second instruction 6004 for reducing 5004 the force required for the actuator to move the wing tip device 9 from the load-alleviating configuration to the flight configuration.

As described with respect to the examples above, reducing 5004 the force required for the actuator to move the wing tip device to the flight configuration may comprise manoeuvring 5004a the aircraft and/or deploying 5004b one or more aircraft control surfaces.

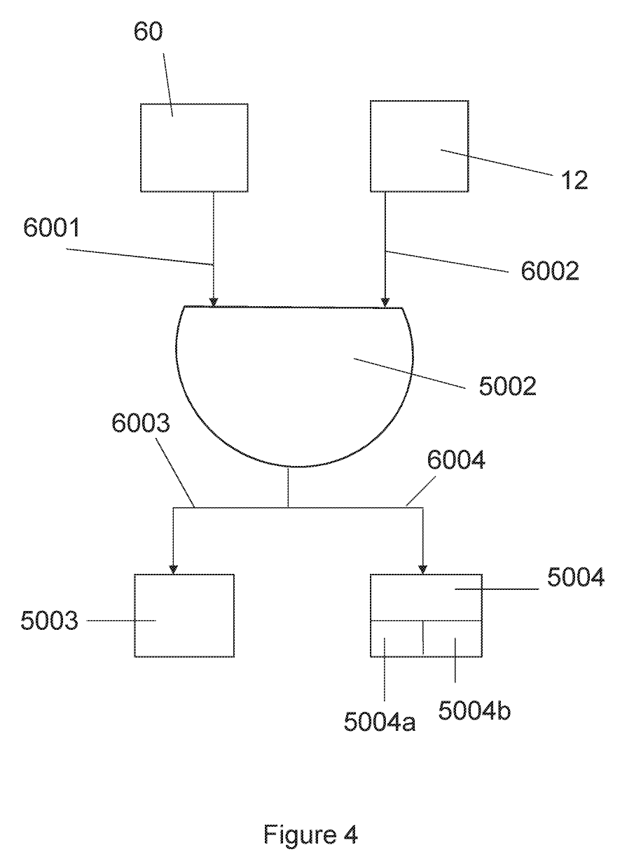

The advantages of the present invention with respect to wing lift, will now be explained with reference to FIGS. 5, 6 and 7.

FIG. 5 is a graph showing lift distribution across the wing of the aircraft of FIG. 1 a during flight (i) with the wing tip device in the load-alleviating configuration; (ii) with the wing tip device in the flight configuration but with the wing tip device aileron deployed; and (iii) with the wing tip device in the flight configuration.

It is clear from plots (i), (ii) and (iii) of FIG. 5 that the wing tip device generates considerable amounts of lift when the wing tip device is in the flight configuration, but the amount of lift generated (and therefore the force required to be applied by the actuator to move the wing tip device into the flight configuration) is much reduced when the wing tip device aileron is deployed.

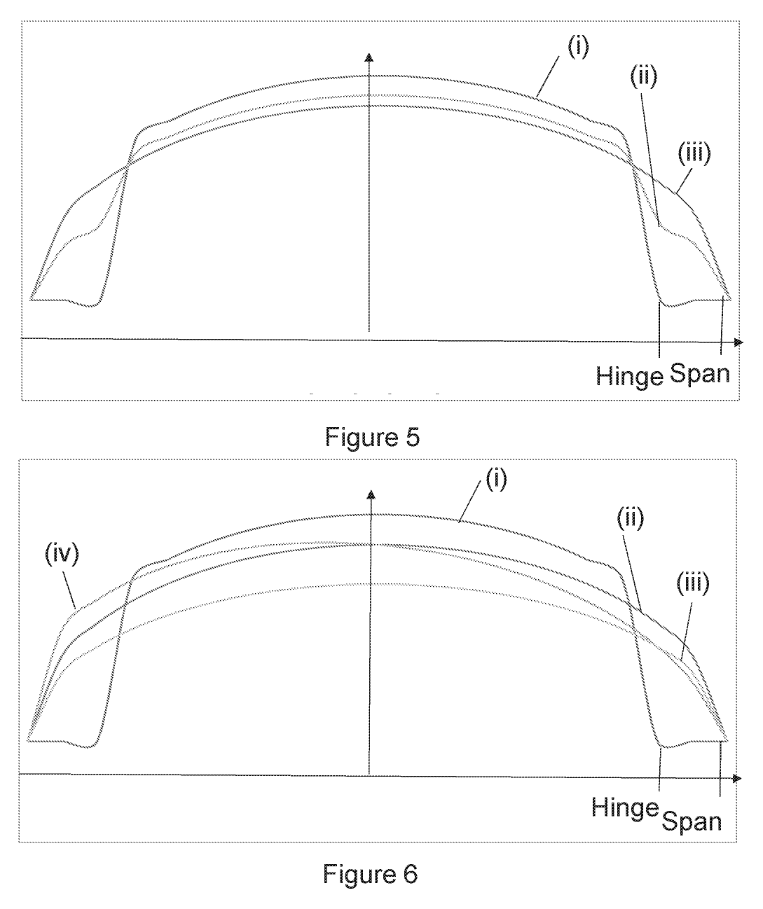

FIG. 6 is a graph showing lift distribution across the wing of the aircraft of FIG. 1 a during flight (i) with the wing tip device in the load-alleviating configuration; (ii) with the wing tip device in the flight configuration; (iii) with the wing tip device in the flight configuration, but with the aircraft flying a parabolic flight path; and (iv) with the wing tip device in the flight configuration, but with the aircraft undergoing a roll manoeuvre.

It is clear from plots (i), (ii), (iii) and (iv) of FIG. 6 that the wing tip device generates considerable amounts of lift when the wing tip device is in the flight configuration, but the amount of lift generated (and therefore the force required to be applied by the actuator to move the wing tip device into the flight configuration) is reduced when the aircraft flies a parabolic flightpath or performs a roll.

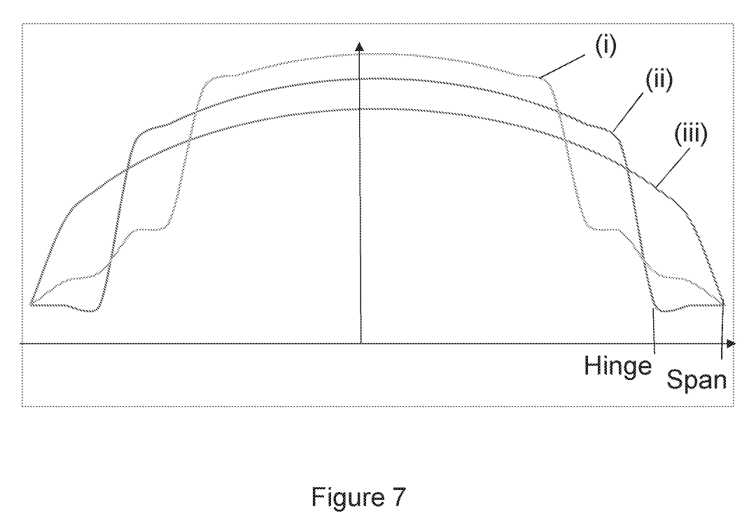

FIG. 7 is a graph showing lift distribution across the wing of the aircraft of FIG. 1a during flight (i) with the wing tip device in the flight configuration, but with the flaps deployed; (ii) with the wing tip device in the load-alleviating configuration; and (iii) with the wing tip device in the flight configuration.

It is clear from plots (i), (ii) and (iii) of FIG. 7 that the wing tip device generates considerable amounts of lift when the wing tip device is in the flight configuration, but the amount of lift generated (and therefore the force required to be applied by the actuator to move the wing tip device into the flight configuration) is much reduced when the flaps are deployed.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

Whilst the examples above use the retraining assembly described in WO2017/118832, those skilled in the art will realise that this is not necessary, and other types of wing tip device and associated actuation assembly may be used.

The examples above relate to twin engine aircraft. Those skilled in the art will realise that the present invention may be used on other aircraft, such as four engine aircraft.

The examples above relate to relatively large aircraft, for example, those having a wing span of about 50-70 metres. Those skilled in the art will recognise that the present invention may be used on other aircraft.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

The term ‘or’ shall be interpreted as ‘and/or’ unless the context requires otherwise.

1. An apparatus for controlling a movable wing tip device of an aircraft, movable from (a) a load-alleviating configuration in which the wing tip device is oriented relative to the fixed wing such that at least one of the upper and lower surface of the wing tip device is positioned away from the respective surface of the fixed wing to (b) a flight configuration in which the upper and lower surfaces of the wing tip device are continuations of the upper and lower surfaces of the fixed wing,
the apparatus comprising:
an actuator configured to apply a force to the wing tip device to move the wing tip device from the load-alleviating configuration to the flight configuration; and
a controller configured to control operation of the actuator;
a processor configured:
to receive a first signal indicative of whether or not the movable wing tip device is in the load-alleviating configuration;
to receive a second signal indicative of a desire to move the movable wing tip device from the load-alleviating configuration to the flight configuration; and
in response to the first signal being indicative that the movable wing tip is in the load-alleviating configuration and to the second signal being indicative of the desire to move the wing tip device into the flight configuration, to generate a first instruction for moving the wing tip device from the load-alleviating configuration to the flight configuration; and to generate a second instruction for controlling operation of the aircraft so as to reduce the force required for the actuator to move the wing tip device from the load-alleviating configuration to the flight configuration;
wherein the controller is configured to control operation of the actuator on receiving the first instruction from the processor.

2. The apparatus according to claim 1, further comprising a sensor for determining whether or not the wing tip device is in the load-alleviating configuration, said sensor being configured to provide the first signal.

3. The apparatus according to claim wherein the sensor is configured to determine the angular displacement of the wing tip device from the flight configuration.

4. The apparatus according to claim wherein the second signal is indicative of the passing of an excessive load-generating event.

5. The apparatus according to claim 1, wherein the second signal is for deploying one or more aircraft control surfaces.

6. (canceled)

7. (canceled)

8. The apparatus according to claim 1, wherein the second instruction is for reducing the angle of attack of the fixed wing by maneuvering the aircraft.

9. The apparatus according to claim 5, wherein the second instruction is for rolling the aircraft in a first roll direction and subsequently in a second roll direction different from the first roll direction.

10. The apparatus according to claim 1, wherein the second instruction is for changing the pitch of the aircraft.

11. The apparatus according to claim 10, in which the second instruction is for increasing the pitch of the aircraft and then reducing the pitch of the aircraft.

12. The apparatus according to claim 1, further comprising a restraining assembly operable between a restraining mode in which the wing tip device is held in the flight configuration using a restraining force, and a releasing mode in which the restraining force on the wing tip device is released, such that the wing tip device is able to adopt the load-alleviating configuration.

13. The apparatus according to claim 1, further comprising a biasing member arranged such that when the wing tip device is in the flight configuration, the biasing member exerts a biasing force to urge the wing tip device towards the load-alleviating configuration.

14. An aircraft comprising the apparatus in accordance with claim 1 and a movably mounted wing tip device which is moveable from a load-alleviating configuration to a flight configuration,
the wing tip device being moveably mounted at the tip of a fixed wing of an aircraft,
the fixed wing having an upper surface and a lower surface, and the wing tip device having an upper surface and a lower surface,
wherein in the flight configuration the upper and lower surfaces of the wing tip device are continuations of the upper and lower surfaces of the fixed wing; and
in the load-alleviating configuration the wing tip device is oriented relative to the fixed wing such that at least one of the upper and lower surfaces of the wing tip device is positioned away from the respective surface of the fixed wing, and the lift provided by the wing is reduced relative to the flight configuration.

15. The aircraft according to claim 14, wherein the wing tip device is rotatably mounted on a hinge at the tip of the wing, such that the wing tip device rotates, about the hinge, between the flight and load-alleviating configurations.

16. The aircraft according to claim 14, further comprising one or more aircraft control surfaces which are deployable in response to the second instruction provided by the processor.

17. (canceled)

18. (canceled)

19. A method of moving a movably mounted wing tip device from a load-alleviating configuration to a flight configuration during flight,
the wing tip device being moveably mounted at the tip of a fixed wing of an aircraft, the fixed wing having an upper surface and a lower surface, and the wing tip device having an upper surface and a lower surface,
wherein in the flight configuration the upper and lower surfaces of the wing tip device are continuations of the upper and lower surfaces of the fixed wing; and
wherein in the load-alleviating configuration the wing tip device is oriented relative to the fixed wing such that at least one of the upper and lower surfaces of the wing tip device is positioned away from the respective surface of the fixed wing, and the load on the wing is reduced relative to the flight configuration,
the aircraft comprising an actuator for applying a force to the wing tip device for moving the wing tip device from the load-alleviating configuration to the flight configuration;
the method comprising reducing the force required for the actuator to move the wing tip device from the load-alleviating configuration to the flight configuration.

20. The method according to claim 19 wherein the step of reducing the force required for the actuator to move the wing tip device from the load-alleviating configuration to the flight configuration comprises moving one or more aircraft control surfaces.

21. The method according to claim 19, wherein the step of reducing the force required for the actuator to move the wing tip device comprises reducing the angle of attack of the fixed wing.

22. The method according to claim 19, wherein the step of reducing the force required for the actuator to move the wing tip device comprises maneuvering the aircraft by rolling the aircraft, and/or reducing the pitch angle of the aircraft.

23. (canceled)

24. The method according to claim 19, further comprising determining whether or not the wing tip device is in the flight configuration or in the load-alleviating configuration, and reducing the force required for the actuator to move the wing tip device from the load-alleviating configuration to the flight configuration dependent on the determination of whether or not the wing tip device is in the flight configuration or in the load-alleviating configuration.

25. The method according to claim 19, further comprising using the actuator to move the wing tip device to the flight configuration.
